(19) United States
(12) Patent Application Publication
(10) Pub. No.: US 2003/0154869 A1
(43) Pub. Date: Aug. 21, 2003

(54) Alcohol stabilizer for offset printing dampening solution

(75) Inventor: Klaus Strobl, Inchenhofen (DE)

Correspondence Address: OSTROLENK FABER GERB & SOFFEN, 1180 AVENUE OF THE AMERICAS, NEW YORK, NY, 100368403

(73) Assignee: Baldwin Germany GmbH

(21) Appl. No.: 10/357,530

(22) Filed: Feb. 3, 2003

(30) Foreign Application Priority Data
Feb. 16, 2002 (DE) 102 06 488.1

(51) Int. Cl. B41L 23/00

(52) U.S. Cl. 101/147

(57) ABSTRACT

Alcohol stabilizer for offset printing dampening solution, with a metering float for metering of alcohol into the dampening solution from a supply. An emergency cut-off float interrupts the supply of alcohol by ventilating the alcohol supply path when the alcohol content in the dampening solution reaches or exceeds an emergency cut-off value. The metered flow of alcohol is introduced into a recirculation path from and then back to a main vessel of the dampening solution.

### BACKGROUND OF THE INVENTION

The invention relates to an alcohol stabilizer apparatus for offset printing dampening solution, which operates to maintain the alcohol concentration in the solution within a desired range.

The dampening solution for offset printing is in a supply vessel from which the solution is removed as needed. Alcohol is selectively added to the supply vessel or the addition of alcohol is halted in order to maintain the desired concentration of alcohol in the dampening solution. A stabilizer for the alcohol in the dampening solution selectively permits or halts the supply of alcohol to the solution as it measures the concentration of alcohol in the solution.

Alcohol stabilizers of this type are known in practice. An alcohol stabilizer is illustrated diagrammatically in U.S. Pat. No. 5,177,975. EP 0 602 312 A1 shows a printing machine thermal control system for cold water and dampening solution.

In dampening solution offset printing, dampening solution is applied to the plate cylinder in order to form ink repelling regions. In dampening solution offset printing, dampening solution may also be used for cleaning of cylinders and for dampening of paper webs.

### SUMMARY OF THE INVENTION

The invention has the object of providing a safety measure to prevent excess alcohol being conveyed into the dampening solution, which may cause damage, for example poor print quality and/or an overflow of the dampening solution device.

According to the invention, the alcohol stabilizer for the offset printing dampening solution contains a dampening solution measuring vessel with an overflow for maintaining the fluid level the measuring vessel, a metering float in the measuring vessel whose float level meters the alcohol and an alcohol supply path to the main dampening solution holding vessel as well as to the measuring vessel for the stabilizer. The alcohol supply path can be selectively connected to the outside via a ventilating valve or to the dampening solution main holding vessel. There is an additional emergency cut-off float in the measuring vessel, having a buoyancy which is dependent upon the alcohol content in the solution for cutting off the alcohol and opening the valve to the outside when the alcohol concentration in the dampening solution reaches or exceeds an emergency cut-off level. There is a recirculation path of the dampening solution from the main holding vessel that holds the dampening solution, through a forward flow line and then through a return flow line into the main holding vessel and also through a further return flow line branching into the measuring vessel.

A fluid pump pumps the fluid into the main holding vessel for the dampening solution. There is also an alcohol supply path connected to the fluid pump. A valve in the alcohol supply path is controlled by the metering float to supply the alcohol to the dampening solution as a function of the floating height of the metering float. The emergency cut-off float also operates in the alcohol supply path.

Other features and advantages of the present invention will become apparent from the following description of the invention which refers to the accompanying drawings.

### BRIEF DESCRIPTION OF THE DRAWINGS

The invention is described below by means of preferred embodiments of examples, with reference to the drawings in which:

FIG. 1 shows diagrammatically a vertical section through an alcohol stabilizer according to the invention for offset printing dampening solution,

FIG. 2 shows a cross section along the plane II-II of FIG. 1,

FIG. 3 shows a detail of a further embodiment of an alcohol stabilizer according to the invention, and

FIG. 4 diagrammatically shows a vertical section through a further embodiment of an alcohol stabilizer for offset printing dampening solution.

### DESCRIPTION OF PREFERRED EMBODIMENTS

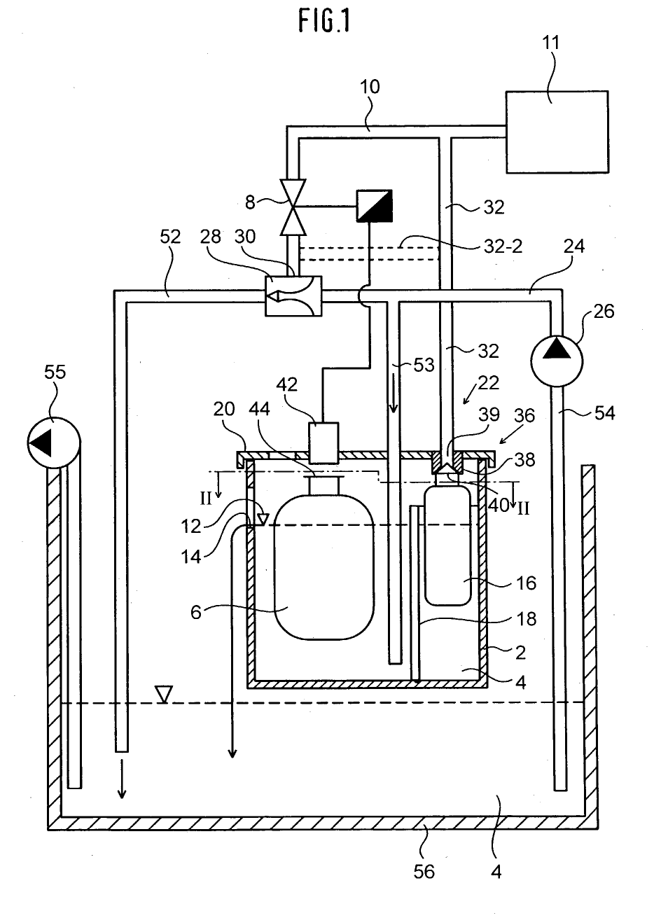

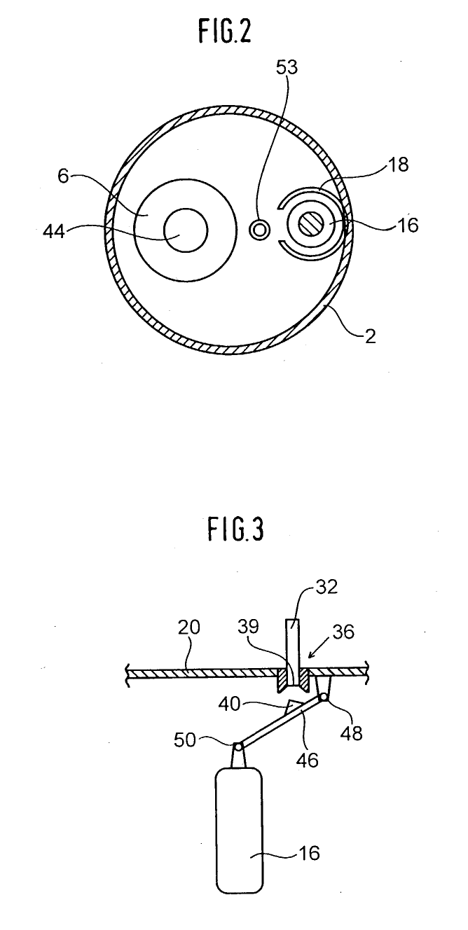

An alcohol stabilizer according to the invention for offset printing dampening solution is illustrated in FIGS. 1 and 2. The stabilizer contains a measuring vessel 2 for containing dampening solution 4. A metering float 6 floats on the solution in the measuring vessel 2. A valve device 8 is disposed in an alcohol supply path 10 which supplies alcohol from an alcohol vessel 11 into the dampening solution. Alcohol is supplied as a function of the buoyancy and the resulting floating height of the metering float 6 in the measuring vessel 2. The buoyancy of the metering float 6 is dependent on the alcohol content of the dampening solution.

The dampening solution level 12 in the measuring vessel 2 is stabilized by an overflow 14 or an overflow wall. Dampening solution is supplied to the measuring vessel 2 continuously or intermittently or in a controlled manner.

An emergency cut-off float 16 also floats on the dampening solution 4 in the measuring vessel 2, so that there is the same dampening solution level 12 for both floats 6 and 16, irrespective of whether the two floats 6 and 16 are arranged in the same chamber or may be in different chambers. If a plurality of chambers are used, these are fluid connected to one another, so that all of them have the same fluid level 12.

The two floats 6 and 16 are separated from one another, preferably by guide walls, for example, an intermediate wall 18 that has passages for the dampening solution 4. This separation prevents the two floats 6 and 16 from disturbing one another. The floats are aligned vertically with elements with which they cooperate and which are arranged on a wall or on a cover 20 of the measuring vessel 2, as described below.

Preferably, atmospheric pressure prevails above the fluid level 12 in the measuring vessel 2, and there is a connection to the outside atmosphere.

The alcohol stabilizer contains an interruption device 22 for interrupting the supply of alcohol into the dampening solution 4 into both the measuring vessel 2 and the main solution vessel 56 as a function of the buoyancy and consequently of the floating height of the emergency cut-off float 16 in relation to the measuring vessel 2. Interruption of supply takes place only when the alcohol content in the dampening solution 4 reaches or exceeds a predetermined emergency cut-off value higher than a predetermined maximum alcohol limit value, for example higher than the maximum desired alcohol value at which the valve device 8 should close, when operating properly, as a function of the floating height of the metering float 6 in normal operation.

The buoyancy and therefore also the floating height of the two floats 6 and 16 in relation to the measuring vessel 2 and consequently also in relation to the fluid level 12 in the vessel are dependent on the density of the dampening solution 4 and therefore on the alcohol content of the dampening solution 4. A high alcohol percentage value provides a low density and therefore a low floating buoyancy to the floating bodies 6 and 16. A low alcohol percentage value provides a high density of the dampening solution 4 and consequently a higher floating buoyancy to the floats 6 and 16.

The invention can be implemented in various ways. Preferred embodiments are described below.

A dampening solution recirculation path 24 contains a dampening solution pump 26 for recirculation of the dampening solution. It contains a fluid jet pump 28 having a suction connection 30, to which the alcohol supply path 10 is connected downstream of the valve device 8, for sucking in alcohol by means of the dampening-solution stream in the fluid jet pump 28 when the valve device 8 is opened.

The interruption device 22 contains a ventilation line 32 which issues into the alcohol supply path 10 and which can be connected to the outside atmosphere as a function of the floating height of the emergency cut-off float 16 in relation to the dampening solution vessel 2. This ventilates the alcohol supply path 10 only when the alcohol content in the dampening solution reaches or exceeds the emergency cut-off value. This has the effect that the fluid jet pump 28 sucks in air, instead of alcohol, from the alcohol supply path 10.

The ventilation line 32 may be connected to the alcohol supply path 10 upstream of the valve device 8 as in FIG. 1 or between the valve device 8 and the fluid jet pump 28, downstream of the valve device 8, as indicated diagrammatically in FIG. 1 by broken line 32-2.

The ventilation line 32 has a ventilation valve 36 which has a valve seat 38 at the ventilation line, a valve-seat orifice 39, and a valve body 40 for being actuated by the emergency cut-off float 16. The ventilation valve 36 is normally kept closed by the emergency cut-off float 16 and is opened only when the emergency cut-off value of the percentage alcohol content in the dampening solution is reached or exceeded. As a result, the emergency cut-off float 16 has a buoyancy in the dampening solution 4 which is reduced by a higher alcohol content, so that it sinks in the dampening solution 4 and thereby moves, together with the valve body 40, away from the valve seat 38.

In the embodiment of FIGS. 1 and 2, the valve body 40 of the ventilation valve 36 is provided on the emergency cut-off float 16, being either formed with it or fastened to it.

The floating height of the metering float 6 in relation to the dampening-solution vessel 2 is determined by a sensor 42 which is actuated by the metering float 6. The metering float 6 may be an actuating element or may be provided with an actuating element 44 to which the sensor 42 responds. The sensor may be a contact sensor, a contactless sensor, a switch or a tracer. The sensor 42 may be arranged at any desired point on the wall or on the cover of the measuring vessel 2. In the illustrated preferred embodiment, the sensor is on the cover 20 of the vessel and is axially aligned with the metering float 6.

FIG. 1 shows an operating state in which the actuating element 44 of the metering float 6 is at a vertical distance below the sensor 42, because and as long as the percentage of alcohol in dampening solution 4 is within a desired value or desired-value range. An increase in the consumption or evaporation of alcohol from the dampening solution 4 decreases the percentage alcohol content of the dampening solution 4. As the density of the dampening solution 4 consequently rises, the metering float 6 rises to the sensor 42. The sensor then opens the valve device 8, in order to supply alcohol via the alcohol supply path 10 to the fluid jet pump 28 and, via the pump 28, to the dampening solution. An increase in alcohol content in the dampening solution 4 decreases the density of the solution. On account of the lower fluid buoyancy, the metering float 6 sinks more deeply into the dampening solution again and therefore moves away from the sensor 42 which recloses the valve device 8 again, when the alcohol percentage value in the dampening solution 4 has reached or exceeds a predetermined alcohol maximum value or alcohol desired value.

During the above described time, the ventilation valve 36 always remains closed. The valve 36 is opened by the emergency cut-off float 16, for reliably limiting the alcohol content, only when the alcohol percentage value exceeds the alcohol limit value, for example the alcohol desired value, up to the emergency cut-off value, to open the ventilation valve 36 and thereby interrupt the supply of alcohol. This is a fault situation and arises only when the valve device 8 is open because of a defect, instead of being closed, even though the alcohol percentage value is above the predetermined limit value at which it should close as intended i.e. the normal situation.

According to the detail of the alcohol stabilizer of FIG. 2, and as shown in FIG. 3, in a further embodiment of the invention, the valve body 40 of the ventilation valve 36 may be provided on a lever 46 which is actuated by the emergency cut-off float 16. The lever arrangement may be a single lever 46 according to FIG. 3 or a multilever arrangement, on which the emergency cut-off float 16 is arranged on a larger lever arm than the valve body 40, to transmit the buoyancy force of the emergency cut-off float 16 in an intensified way to the valve body 40 and from the latter to the valve seat 38. In FIG. 3, the lever arrangement preferably has only a single lever 46 which is fastened pivotally at one lever end to the dampening solution vessel 2 or its cover 20 by a joint 48 and at the other lever end, to the emergency cut-off float 16 by a further joint 50. The joint 50 is preferably at the upper end of the float.

The fluid jet pump 28 is preferably arranged in a delivery line 52 of the dampening solution recirculation path 24. In another embodiment, the pump could also be arranged in a suction line 54 of the dampening solution recirculation circuit 24.

The dampening solution recirculation path 24 contains a forward-flow line 54 with the dampening solution pump 26 and two return flow lines 52 and 53. One return flow line 53 issues into the measuring vessel 2 and the second return flow line 52 issues into the main dampening solution tank or vessel 56. The second return flow line 52 contains the fluid jet pump 28. Dampening solution 4 can be conveyed out of the dampening solution tank 56 to a printing machine by a pump 55.

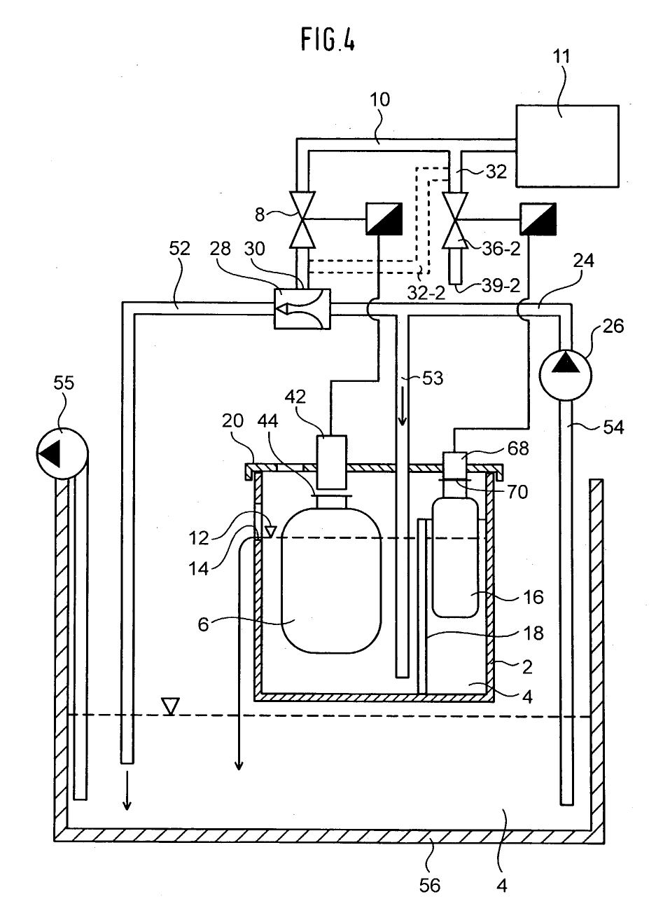

The embodiment of FIG. 4 is identical to that of FIGS. 1 and 2, except that the emergency cut-off float 16 is not a mechanical part of the ventilation valve 36, but instead cooperates with a sensor 68 fastened to the measuring vessel 2, and preferably to the cover 20 of the vessel. The sensor 68 opens a normally closed ventilation valve 36-2, in order to connect a ventilation orifice 39-2, which is connected to the outside atmosphere, to the alcohol supply path 10 and to ventilate the path 10 when the emergency cut-off float 16 moves away from the emergency cut-off sensor 68 because the alcohol percentage value in the dampening solution 4 has reached or exceeded the emergency cut-off value. This situation may arise when the valve device 8 in the alcohol supply path 10 is not closed owing to a defect, so that the alcohol percentage value reaches the predetermined alcohol limit value.

The emergency cut-off sensor 68 may be a contact sensor, a contactless sensor, a tracer or a switch. It may be actuated by the emergency cut-off float 16 directly or by means of an actuating element 70 provided on the emergency cut-off float 16.

The remaining description relating to FIGS. 1 and 2 applies to corresponding features of FIG. 4.

In all the embodiments, the valve device 8 in the alcohol supply path 10 is preferably a valve device closed in the electric currentless state. It is opened by an electrical voltage which is applied as a function of the floating level of the metering float 6. The ventilation valve 36-2 is preferably open in the currentless state and for closing, it is supplied with electrical voltage as a function of the floating level of the emergency cut-off float 16.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An alcohol stabilizer for offset printing dampening solution, wherein the alcohol stabilizer is for controlling the concentration of alcohol in a supply of dampening in solution in a main dampening solution vessel, the stabilizer comprising:
a dampening solution measuring vessel, a device in the measuring vessel for setting a dampening solution level in the measuring vessel;
a metering float floating in the measuring vessel for adjusting the float level of the metering float dependent upon the concentration of alcohol in the dampening solution in the measuring vessel;
an alcohol supply, a valve from the alcohol supply for selectively permitting and halting the delivery of alcohol to the main dampening solution vessel;
the metering float being connected with the valve from the alcohol supply for the metering float to open the valve and permit addition of the alcohol when the alcohol concentration in the dampening solution decreases and the metering float rises, and for the metering float to close the valve from the alcohol supply when the concentration of alcohol in the damping solution increases and the metering float sinks;
a recirculation path for dampening solution, leading out of the main dampening solution vessel and then into the main dampening solution vessel;
a pump in the recirculation path for pumping the dampening solution through the recirculation path, the valve from the alcohol supply being connected to the pump so that operation of the pump with the valve open moves alcohol into the recirculation path and into the main dampening solution vessel;
a connection from the alcohol supply path not to the valve or to the recirculation path;
an emergency cut-off float in the measuring vessel which floats up and sinks in the damping solution in the measuring vessel as a function of the concentration of the alcohol in the dampening solution, including a second valve connected with the emergency cut-off float for preventing the flow of alcohol to the first valve when the alcohol content in the dampening solution reaches or exceeds an emergency cut-off value, which is higher than a pre-determined maximum alcohol limit value at which the first valve should close and as a function of the floating height of the emergency cut-off float in the dampening solution.

2. The alcohol stabilizer of claim 1, wherein the second valve is a ventilation valve connected to the outside atmosphere, communicating alcohol from the supply to the outside atmosphere when the ventilation valve is open, and the ventilation valve opening when the emergency cut-off float sinks due to an elevated level of alcohol in the dampening solution in the measuring vessel.

3. The alcohol stabilizer of claim 2, wherein the recirculation path communicates into the measuring vessel for supplying dampening solution in the recirculation path to the measuring vessel.

4. The alcohol stabilizer of claim 3, wherein the recirculation path comprises a forward flow line from the main dampening solution vessel, a first return flow line into the main dampening solution vessel and a second return flow line into the measuring vessel, and the pump moves the solution through the forward flow line and the first and second return flow lines.

5. The alcohol stabilizer of claim 4, further comprising a pump in the forward flow line for pumping the dampening solution for recirculation.

6. The alcohol stabilizer of claim 2, wherein the ventilation valve includes a valve seat on the measuring vessel and a valve seat orifice through the seat and comprises a valve body which is so connected with the emergency cut-off float that the valve body operates toward and away from the valve seat for selectively opening and closing the ventilation valve based upon the rising and sinking of the emergency cut-off float dependent upon the concentration of alcohol in the dampening solution in the measuring vessel.

7. The alcohol stabilizer of claim 6, wherein the valve body of the ventilation valve is fastened on the emergency cut-off float.

8. The alcohol stabilizer of claim 6, further comprising a lever connected with the emergency cut-off float, and the valve body of the ventilation device being provided on the lever, whereby the emergency cut-off float engages the valve body through a lever arm of the lever for transmitting the buoyancy force of the emergency cut-off float in an intensified manner to the valve body and from the valve body to the valve seat.

9. The alcohol stabilizer of claim 2, wherein the ventilation valve comprises an electromagnetic valve and a sensor so connected with the emergency cut-off float is actuated by the float, and the sensor being connected with the ventilation valve for selectively operating the ventilation valve when the sensor senses the rising and sinking of the emergency cut-off float.

10. The alcohol stabilizer of claim 1, wherein the device for setting the fluid level in the measuring vessel comprises an overflow outlet from the measuring vessel.

11. The alcohol stabilizer of claim 1, wherein the pump in the recirculation path comprises a fluid jet pump and a line from the alcohol supply connected as an inlet to the fluid jet pump.

12. The alcohol stabilizer of claim 1, wherein both of the metering float and the emergency cut-off float float vertically in the dampening solution.

13. The alcohol stabilizer of claim 12, further comprising guide walls in the measuring vessel for guiding the floats vertically.

14. The alcohol stabilizer of claim 13, wherein the guide walls in the measuring vessel separate the metering float and the emergency cut-off float but provide a common supply of the dampening solution to the floats so that the floats float as a function of the alcohol content of the dampening solution in the measuring vessel.
